(19) United States
(12) Patent Application Publication
(10) Pub. No.: US 2025/0370515 A1
(43) Pub. Date: Dec. 4, 2025

(54) ELECTRONIC DEVICE

(71) Applicant: ASUSTeK COMPUTER INC., Taipei City (TW)

(72) Inventor: Yan-Qin Wang, Taipei City (TW)

(73) Assignee: ASUSTeK COMPUTER INC., Taipei City (TW)

(21) Appl. No.: 19/008,643

(22) Filed: Jan. 3, 2025

(30) Foreign Application Priority Data
May 29, 2024 (TW) 113205548

(51) Int. Cl. G06F 1/16

(52) U.S. Cl. CPC G06F 1/1681

(57) ABSTRACT

An electronic device includes first body, second body and a hinge structure connected between the first and second bodies. The hinge structure includes a rotating shaft, first and second brackets, and at least one torsion element. The first bracket is connected to the first body and the rotating shaft. The second bracket is connected to the second body and pivoted on the rotating shaft. The torsion element is sleeved on the rotating shaft and has opposite first torsion end connected to the first bracket and second torsion end connected to the second bracket. When the first bracket is gradually closed relative to the second bracket, the torsion element provides a first torque to the first bracket through the first torsion end. When the first bracket is gradually unfolded relative to the second bracket, the torsion element provides a second torque to the second bracket through the second torsion end.

### CROSS-REFERENCE TO RELATED APPLICATION

This application claims the priority benefit of Taiwan application serial no. 113205548, filed on May 29, 2024. The entirety of the above-mentioned patent application is hereby incorporated by reference herein and made a part of this specification.

### BACKGROUND

### Technical Field

The disclosure relates to an electronic device, and particularly relates to a foldable electronic device.

### Description of Related Art

Foldable electronic devices are commonly connected between two machine bodies using a hinge structure, allowing the two bodies to unfold or close relative to each other. Generally speaking, users place the foldable electronic device on a tabletop. However, in existing foldable electronic devices, when the two bodies are unfolded, the body positioned on top is difficult to lift up due to the weight of the body, while when the top body is rotated toward the tabletop or the body positioned on bottom, the top body tends to quickly fall due to the weight of the body. As a result, users are required to use both hands to open and close the two bodies of the foldable electronic device, which is quite inconvenient. Therefore, how to increase the convenience of using the two bodies of the foldable electronic device is an important issue in this field.

### SUMMARY

The disclosure provides an electronic device, including a first body, a second body, and a hinge structure. The hinge structure is connected between the first body and the second body. The hinge structure includes a rotating shaft, a first bracket, a second bracket, and at least one torsion element. The first bracket is connected to the first body and rotating shaft. The second bracket is connected to the second body and pivoted on the rotating shaft. The torsion element is sleeved on the rotating shaft, and the torsion element has a first torsion end and a second torsion end opposite to each other. The first torsion end is connected to the first bracket, and the second torsion end is connected to the second bracket. When the first bracket is gradually closed relative to the second bracket, the at least one torsion element provides a first torque to the first bracket through the first torsion end. When the first bracket is gradually unfolded relative to the second bracket, the at least one torsion element provides a second torque to the second bracket through the second torsion end.

Based on the above, in the electronic device of the disclosure, the first torsion end is connected to the first bracket, and the second torsion end is connected to the second bracket, when the first bracket is gradually closed relative to the second bracket, the at least one torque component provides the first torque to the first bracket through the first torque end, and when the first bracket is gradually unfolded relative to the second bracket, the at least one torsion element provides the second torque to the second bracket through the second torsion end, thereby providing the user with the convenience of operating the unfolding and closing of the first body relative to the second body with one hand.

### BRIEF DESCRIPTION OF THE DRAWINGS

FIG. 1A is a schematic view of an electronic device in a second state according to the first embodiment of the disclosure.

FIG. 1B is a perspective schematic view of a hinge structure in FIG. 1A.

FIG. 1C and FIG. 1D are exploded schematic views of the hinge structure in FIG. 1B from different viewing angles.

FIG. 2A is a schematic view of the electronic device in FIG. 1A in a first state.

FIG. 2B is a perspective schematic view of the hinge structure in FIG. 2A.

FIG. 3A is a schematic view of the electronic device in FIG. 1A in a third state.

FIG. 3B is a perspective schematic view of the hinge structure in FIG. 3A.

FIG. 4A is a schematic view of the electronic device in the second state according to the second embodiment of the disclosure.

FIG. 4B is a perspective schematic view of the hinge structure in FIG. 4A.

FIG. 4C and FIG. 4D are exploded schematic views of the hinge structure in FIG. 4B from different viewing angles.

FIG. 5A is a schematic view of the electronic device in FIG. 4A in the first state.

FIG. 5B is a perspective schematic view of the hinge structure in FIG. 5A.

FIG. 6A is a schematic view of the electronic device in FIG. 4A in the third state.

FIG. 6B is a perspective schematic view of the hinge structure in FIG. 6A.

FIG. 7A is a perspective schematic view of the hinge structure according to the third embodiment of the disclosure.

FIG. 7B and FIG. 7C are exploded schematic views of the hinge structure in FIG. 7A from different viewing angles.

FIG. 8 is a perspective schematic view of the hinge structure in FIG. 7A in the first state.

FIG. 9 is a p perspective schematic view of the hinge structure in FIG. 7A in the third state.

### DESCRIPTION OF THE EMBODIMENTS

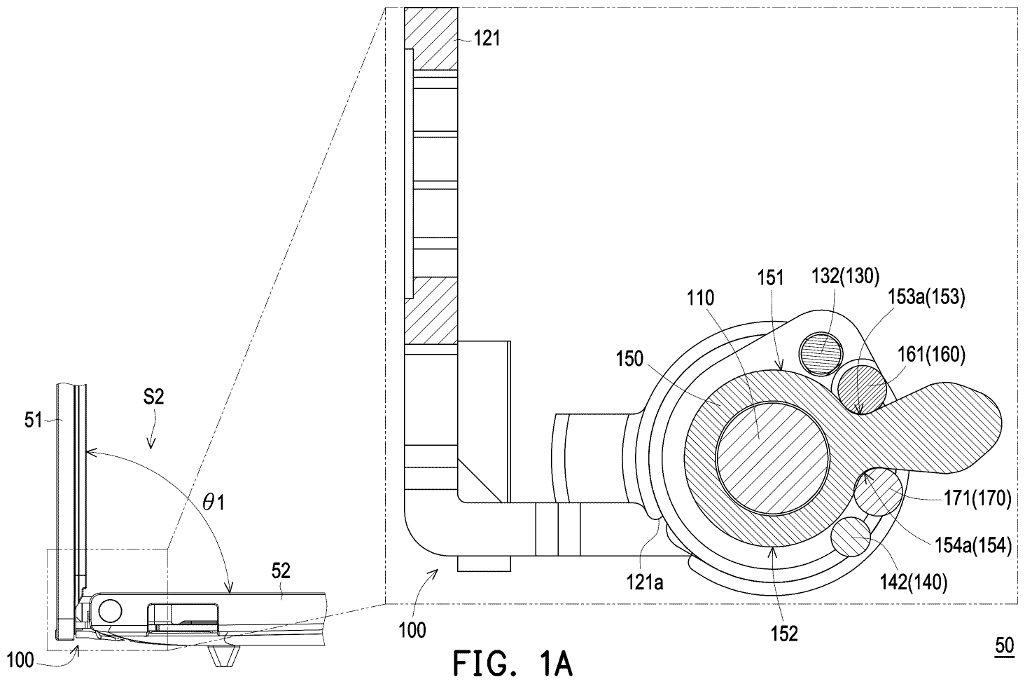

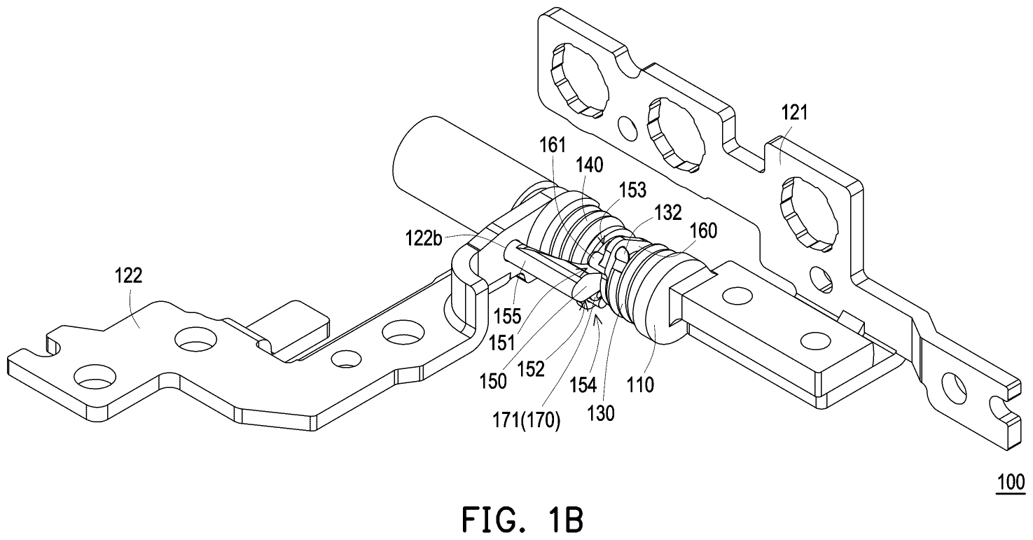

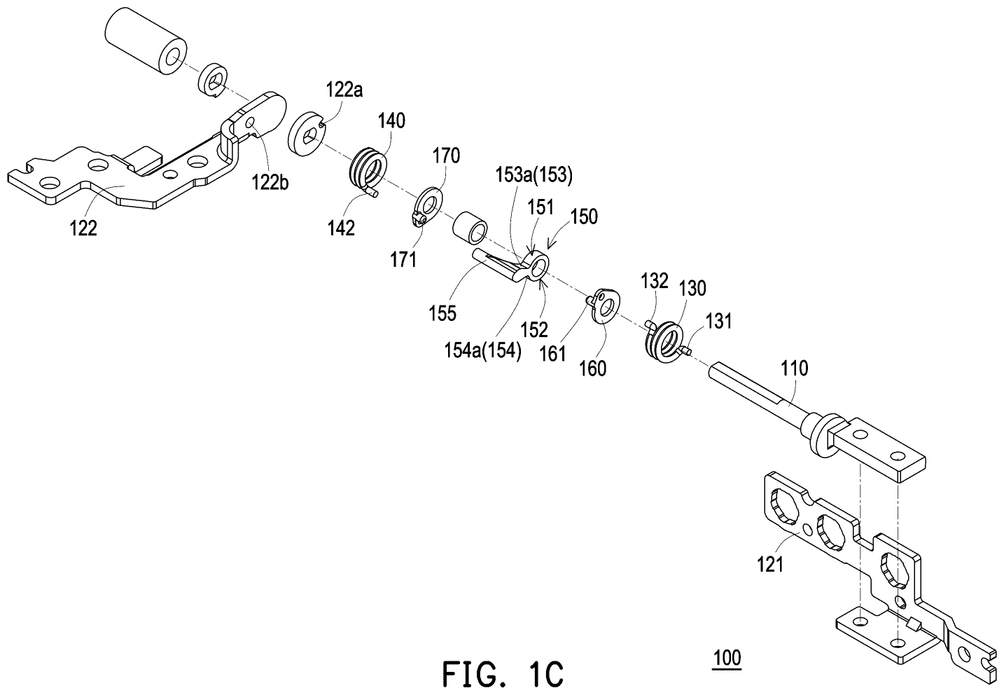

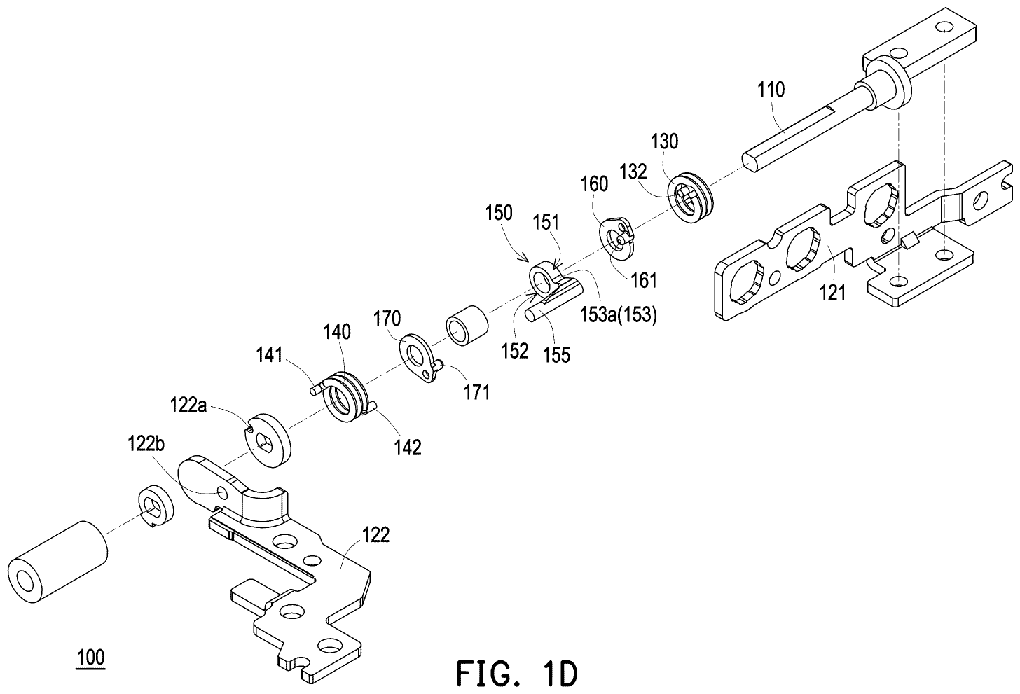

Please refer to FIG. 1A, FIG. 1B, FIG. 1C, and FIG. 1D. An electronic device 50 in the disclosure is, for example, a foldable electronic device, but the disclosure is not limited thereto. The electronic device 50 includes a first body 51, a second body 52, and a hinge structure 100, in which the hinge structure 100 is connected between the first body 51 and the second body 52.

The hinge structure 100 includes a rotating shaft 110, a first bracket 121, a second bracket 122, and at least one torsion element. The first bracket 121 is connected to the first body 51 and the rotating shaft 110. The second bracket 122 is connected to the second body 52 and pivoted on the rotating shaft 110. The torsion element is sleeved on the rotating shaft 110, and the torsion element has a first torsion end 131 and a second torsion end 141 opposite to each other. The first torsion end 131 is connected to the first bracket 121, and the second torsion end 141 is connected to the second bracket 122.

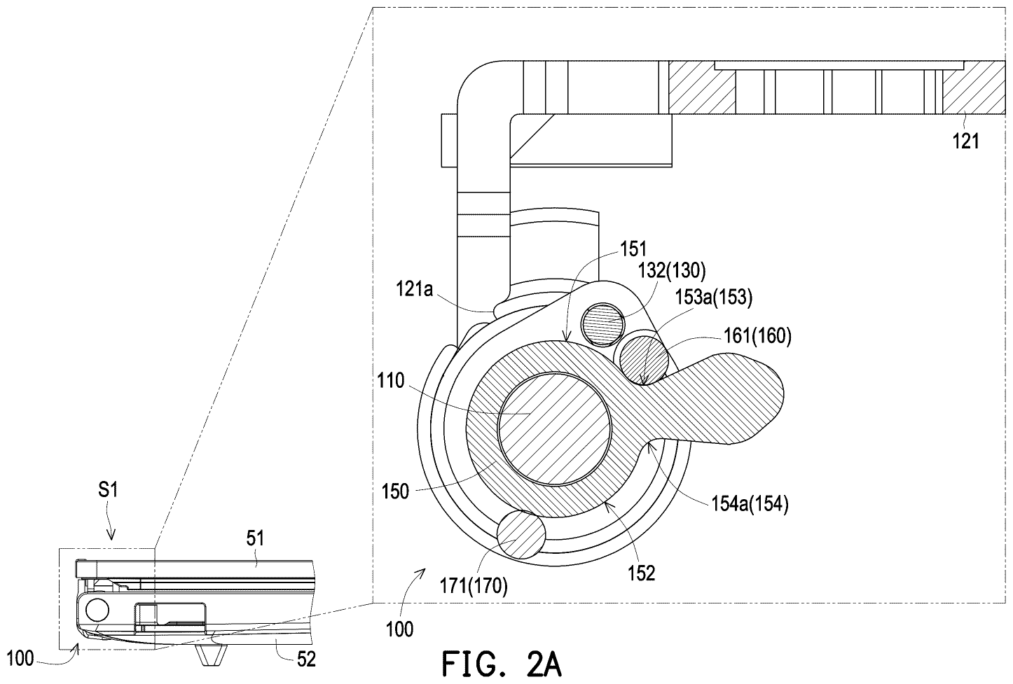

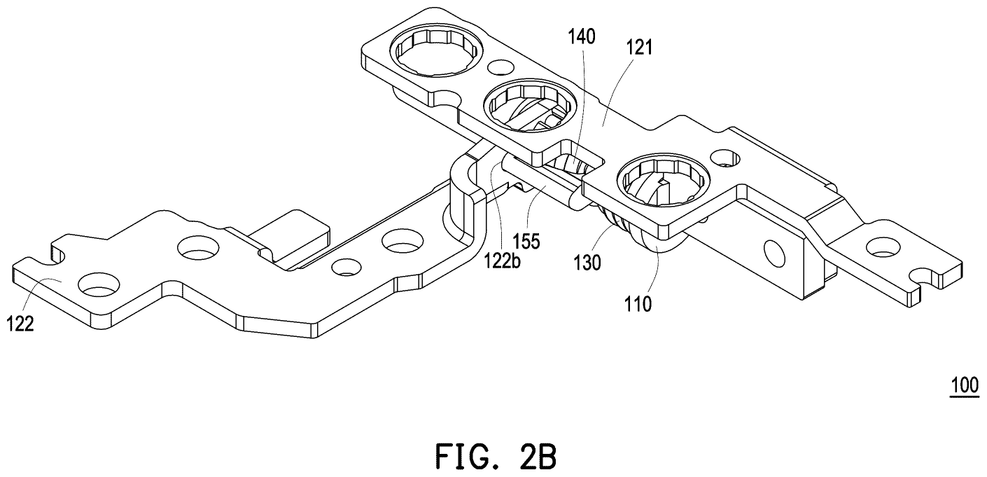

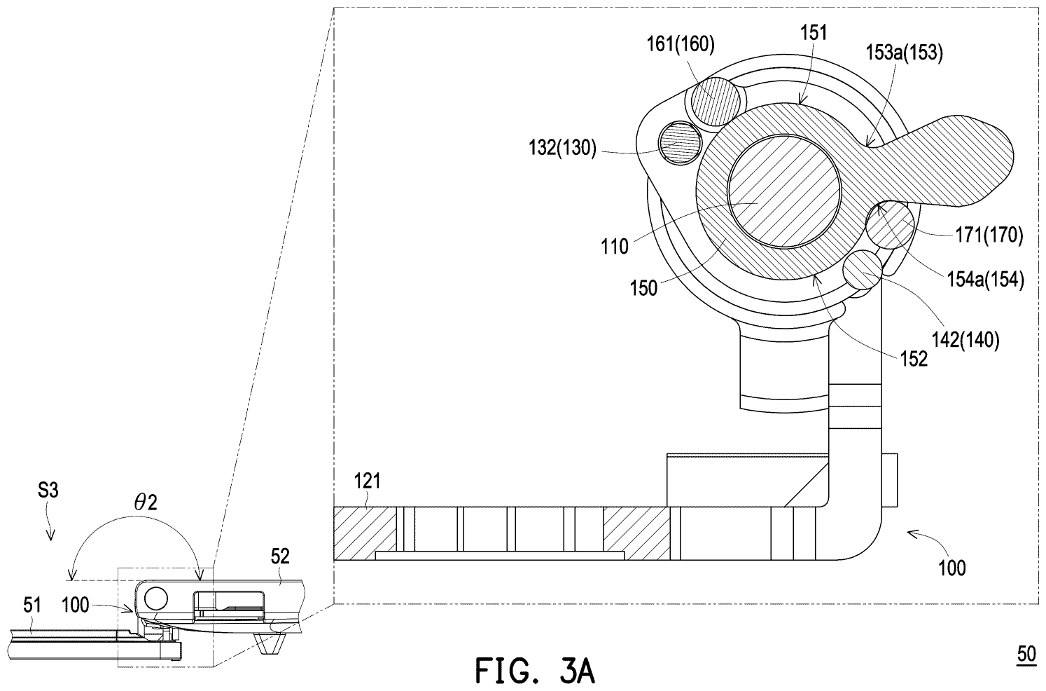

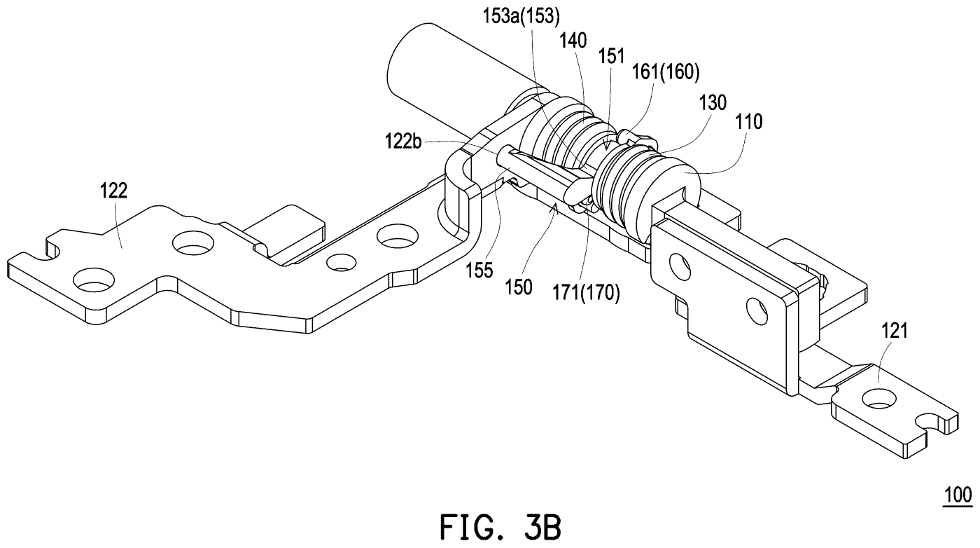

Please refer to FIG. 1A, FIG. 1B, FIG. 2A, and FIG. 2B. When the first bracket 121 is gradually closed relative to the second bracket 122, the at least one torsion element provides a first torque to the first bracket 121 through the first torsion end 131. Please refer to FIG. 1A, FIG. 1B, FIG. 3A, and FIG. 3B. When the first bracket 121 is gradually unfolded relative to the second bracket 122, the at least one torsion element provides a second torque to the second bracket 122 through the second torsion end 141, thereby providing the user with the convenience of operating the unfolding and closing of the first body 51 relative to the second body 52 with one hand.

Please refer to FIG. 1A, FIG. 1B, FIG. 1C, and FIG. 1D. In an embodiment, the hinge structure 100 further includes a fastening component 150, a first rotating component 160, a second rotating component 170, a first torsion element 130, and a second torsion element 140.

The fastening component 150 is sleeved on the rotating shaft 110, and the fastening component 150 is connected to the second bracket 122. The fastening component 150 has a first movable area 153 and a second movable area 154 opposite to each other.

The first rotating component 160 is rotatably sleeved on the rotating shaft 110, and the first rotating component 160 has a first abutting part 161, in which the first abutting part 161 is adapted to move freely within a range of the first movable area 153.

The second rotating component 170 is rotatably sleeved on the rotating shaft 110, and the second rotating component 170 has a second abutting part 171, in which the second abutting part 171 is adapted to move freely within a range of the second movable area 154, and the first rotating component 160 and the second rotating component 170 are on two opposite sides of the fastening component 150.

The first torsion element 130 is sleeved on the rotating shaft 110, and the first torsion element 130 has a first fastening end 132 opposite to the first torsion end 131, in which the first fastening end 132 is connected to the first rotating component 160, and the first rotating component 160 is between the fastening component 150 and the first torsion element 130.

The second torsion element 140 is sleeved on the rotating shaft 110, and the second torsion element 140 has a second fastening end 142 opposite to the second torsion end 141, in which the second fastening end 142 is connected to the second rotating component 170, and the second rotating component 170 is between the fastening component 150 and the second torsion element 140.

In an embodiment, the first bracket 121 has a first slot 121a, and the second bracket 122 has a second slot 122a, in which the first torsion end 131 is engaged with the first slot 121a, and the second torsion end 141 is engaged with the second slot 122a. It should be noted that, in the disclosure, the first slot 121a is indirectly connected to the first bracket 121 by using other components, and the second slot 122a is indirectly connected to the second bracket 122 by using other components, but the disclosure is not limited thereto.

In other embodiments, the first bracket and the first slot may be of an integral structure, and the second bracket and the second slot may be of an integral structure.

In an embodiment, the second bracket 122 has a positioning hole 122b, the fastening component 150 has a positioning part 155, and the positioning part 155 is engaged with the positioning hole 122b.

In an embodiment, the fastening component 150 has a first side 151 and a second side 152 opposite to each other, the first movable area 153 is on the first side 151, and the second movable area 154 is on the second side 152.

In an embodiment, the first movable area 153 has a first stop point 153a, and the second movable area 154 has a second stop point 154a opposite to the first stop point 153a, in which the first abutting part 161 is adapted to abut against or move away from the first stop point 153a, and the second abutting part 171 is adapted to abut against or move away from the second stop point 154a.

Please refer to FIG. 1A, FIG. 1C, FIG. 1D, FIG. 2A, and FIG. 3A. The electronic device 50 is adapted to switch between a first state S1, a second state S2, and a third state S3. In the first state S1, the first body 51 is closed relative to the second body 52. In the second state S2, the first body 51 is unfolded by a first included angle θ1 relative to the second body 52. In the third state S3, the first body 51 is unfolded by a second included angle θ2 relative to the second body 52, and the second included angle θ2 is greater than the first included angle θ1. When the electronic device 50 is in the second state S2, the first abutting part abuts against the first stop point 153a, the second abutting part abuts against the second stop point 154a, and the first torsion element 130 and the second torsion element 140 have not yet accumulated elastic potential energy.

Please refer to FIG. 1A, FIG. 1B, FIG. 1C, FIG. 2A and FIG. 2B. When the electronic device 50 is transitioning from the second state S2 to the first state S1, the first bracket 121 is gradually closed relative to the second bracket 122, the first abutting part 161 continues to abut against the first stop point 153a and the first torsion element 130 gradually accumulates elastic potential energy to provide the first torque, and the second abutting part 171 gradually moves away from the second stop point 154a.

Please refer to FIG. 1A, FIG. 1B, FIG. 1C, FIG. 3A and FIG. 3B. When the electronic device 50 is transitioning from the second state S2 to the third state S3, the first bracket 121 is gradually unfolded relative to the second bracket 122, the second abutting part 171 continues to abut against the second stop point 154a and the second torsion element 140 gradually accumulates elastic potential energy to provide the second torque, and the first abutting part 161 gradually moves away from the first stop point 153a.

Please refer to FIG. 1A, FIG. 1B, FIG. 1C, FIG. 2A, and FIG. 2B. When the electronic device 50 is transitioning from the first state S1 to the second state S2, the first bracket 121 is gradually unfolded relative to the second bracket 122, the second abutting part 171 gradually moves closer to the second stop point 154a, the first abutting part 161 continues to abut against the first stop point 153a, and the first torsion element 130 gradually releases the elastic potential energy to provide a third torque.

Please refer to FIG. 1A, FIG. 1B, FIG. 1C, FIG. 3A, and FIG. 3B. When the electronic device 50 is transitioning from the third state S3 to the second state S2, the first bracket 121 is gradually closed relative to the second bracket 122, the first abutting part 161 gradually moves closer to the first stop point 153a, the second abutting part 171 continues to abut against the second stop point 154a, and the second torsion element 140 gradually releases the elastic potential energy to provide a fourth torque.

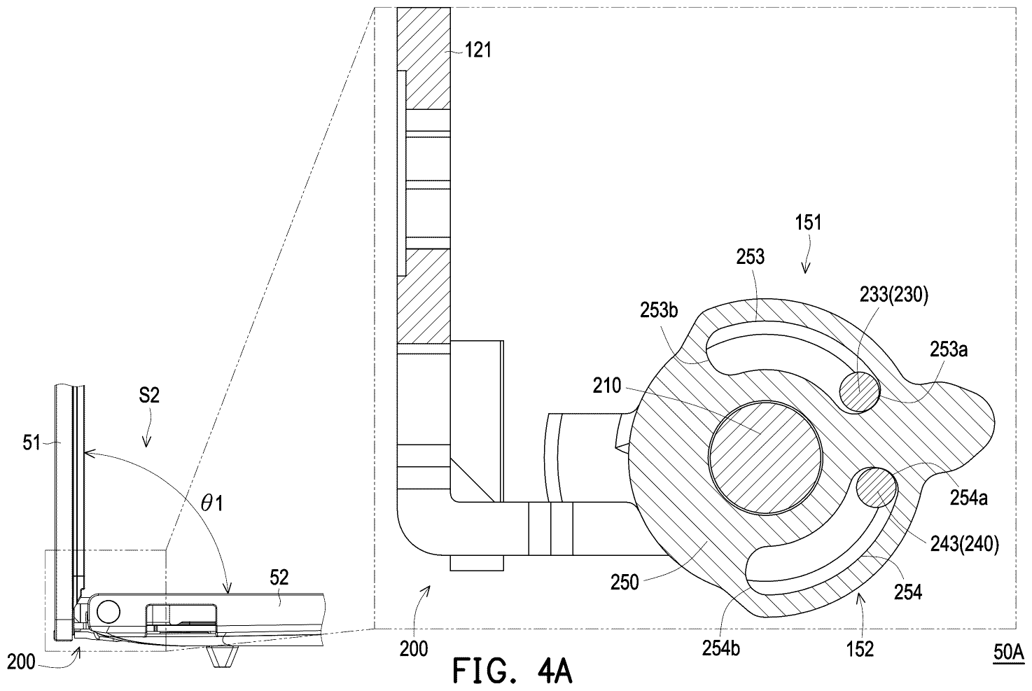

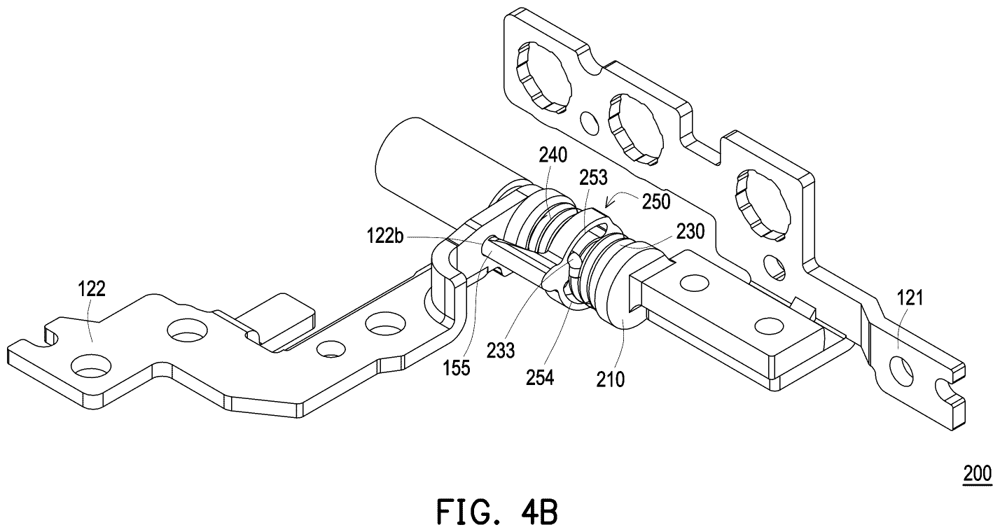

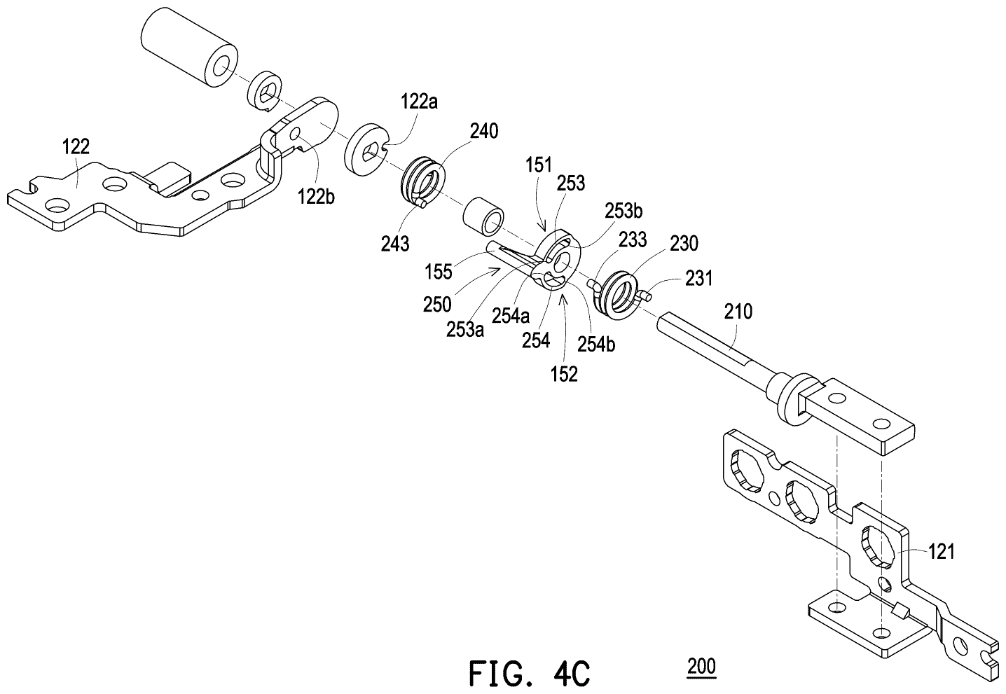

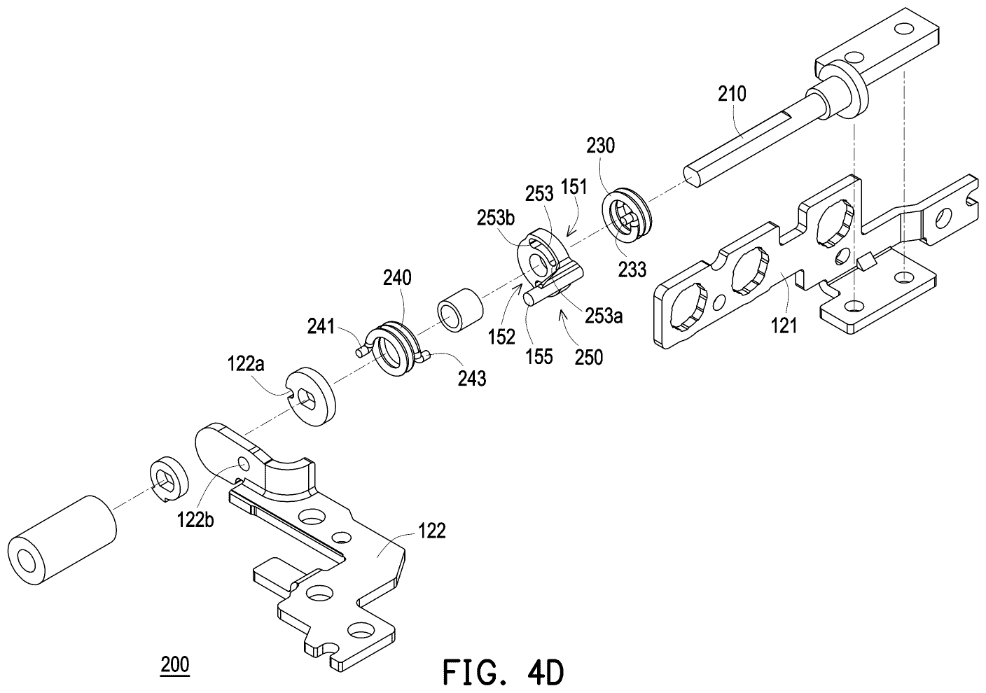

Please refer to FIG. 4A, FIG. 4B, FIG. 4C, and FIG. 4D. The difference between an electronic device 50A of this embodiment and the electronic device 50 of the previous embodiment is that the structure of a hinge structure 200 is more streamlined, and components including the first rotating component and the second rotating component are omitted.

In the hinge structure 200 of this embodiment, the hinge structure 200 further includes a fastening component 250, a first torsion element 230, and a second torsion element 240. The fastening component 250 is sleeved on the rotating shaft 210, and the fastening component 250 is connected to the second bracket 122. The fastening component 250 has a first movable area 253 and a second movable area 254 opposite to each other. The first torsion element 230 is sleeved on the rotating shaft 210, and the first torsion element 230 has a first abutting part 233 opposite to the first torsion end 231, in which the first abutting part 233 is adapted to move freely within a range of the first movable area 253. The second torsion element 240 is sleeved on the rotating shaft 210, and the second torsion element 240 has a second abutting part 243 opposite to the second torsion end 241, in which the second abutting part 243 is adapted to move freely within a range of the second movable area 254, and the first torsion element 230 and the second torsion element 240 are on two opposite sides of the fastening component 250.

The first movable area 253 has a first stop point 253a and a third stop point 253b opposite to each other, and the second movable area 254 has a second stop point 254a and a fourth stop point 254b opposite to each other, in which the first abutting part 233 is adapted to abut against the first stop point 253a or the third stop point 253b, and the second abutting part 243 is adapted to abut against the second stop point 254a or the fourth stop point 254b.

The following describes the operating principle of the hinge structure 200 of the second embodiment.

When the electronic device 50A is in the second state S2, the first abutting part abuts against the first stop point 253a, the second abutting part abuts against the second stop point 254a, and the first torsion element 230 and the second torsion element 240 have not yet accumulated elastic potential energy.

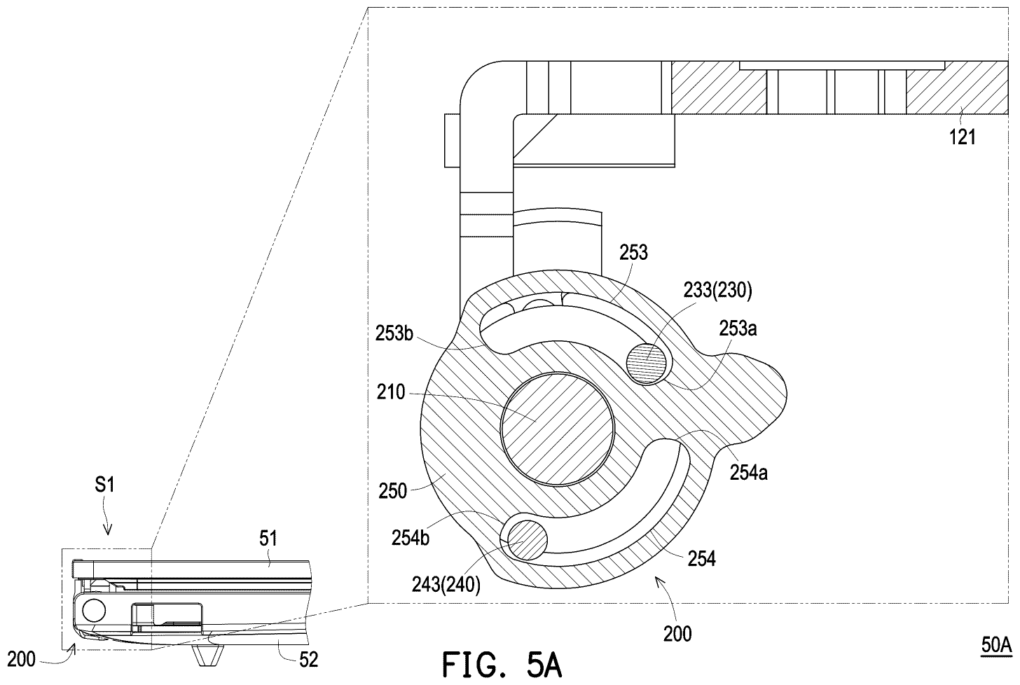

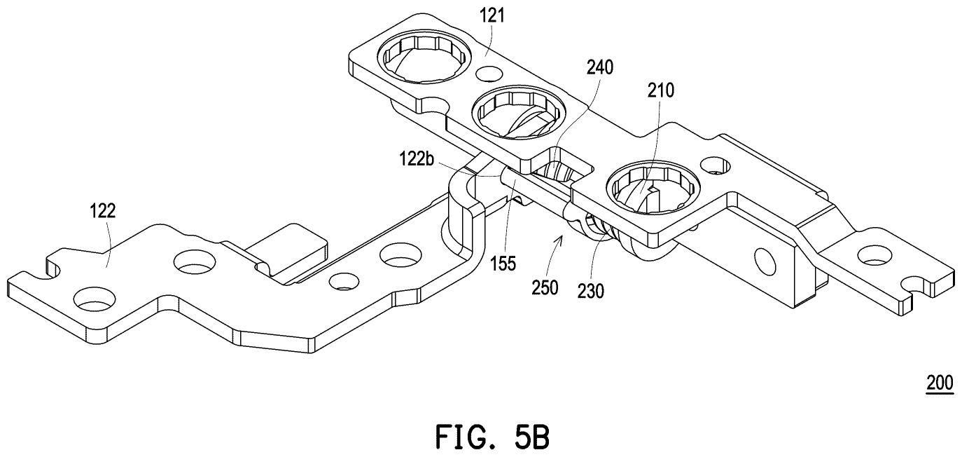

Please refer to FIG. 4A, FIG. 4B, FIG. 4C, FIG. 5A, and FIG. 5B. When the electronic device 50A is transitioning from the second state S2 to the first state S1, the first bracket 121 is gradually closed relative to the second bracket 122, the first abutting part 233 continues to abut against the first stop point 253a and the first torsion element 230 gradually accumulates elastic potential energy to provide the first torque, and the second abutting part 243 gradually moves away from the second stop point 254a and gradually moves closer to the fourth stop point 254b.

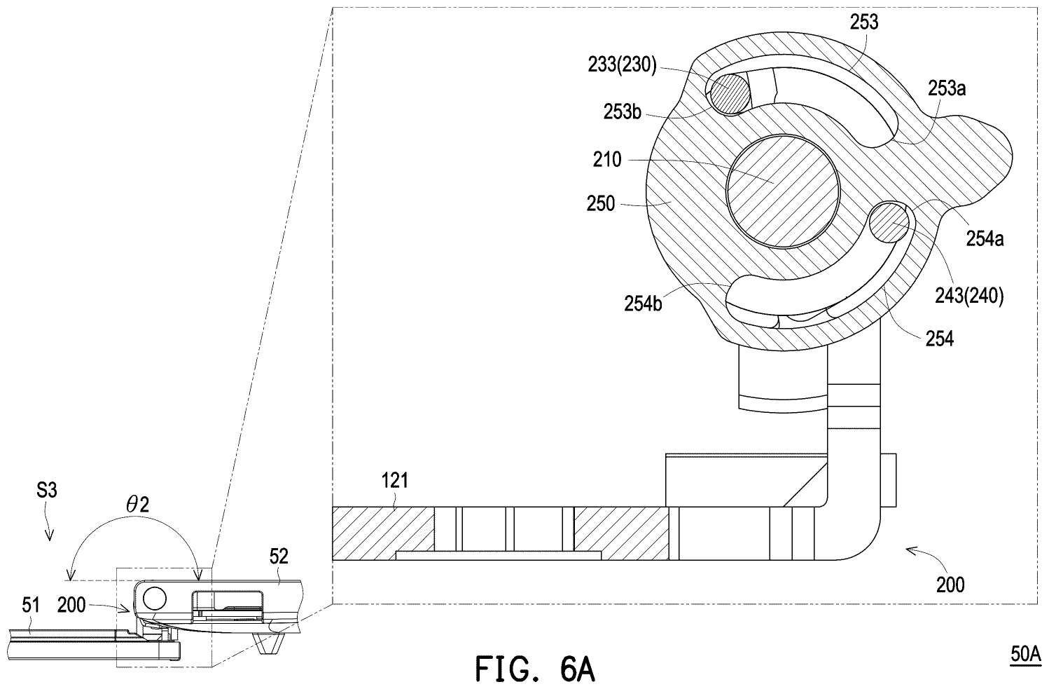

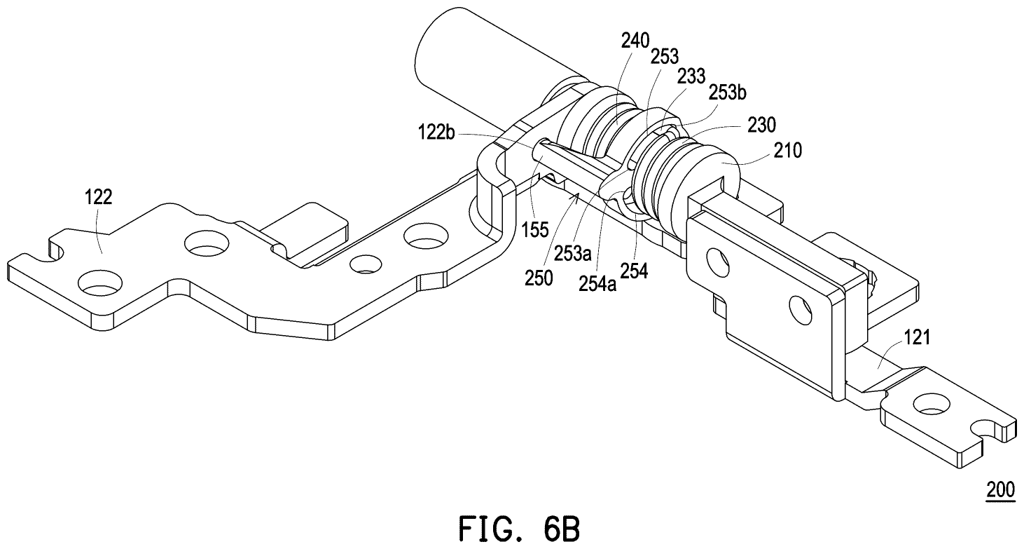

Please refer to FIG. 4A, FIG. 4B, FIG. 4C, FIG. 6A, and FIG. 6B. When the electronic device 50A is transitioning from the second state S2 to the third state S3, the first bracket 121 is gradually unfolded relative to the second bracket 122, the second abutting part 243 continues to abut against the second stop point 254a and the second torsion element 240 gradually accumulates elastic potential energy to provide the second torque, and the first abutting part 233 gradually moves away from the first stop point 253a and gradually moves closer to the third stop point 253b.

Please refer to FIG. 4A, FIG. 4B, FIG. 4C, FIG. 5A, and FIG. 5B. When the electronic device 50A is transitioning from the first state S1 to the second state S2, the first bracket 121 is gradually unfolded relative to the second bracket 122, the second abutting part 243 gradually moves closer to the second stop point 254a from the fourth stop point 254b, the first abutting part 233 continues to abut against the first stop point 253a, and the first torsion element 230 gradually releases the elastic potential energy to provide the third torque.

Please refer to FIG. 4A, FIG. 4B, FIG. 4C, FIG. 6A, and FIG. 6B. When the electronic device 50A is transitioning from the third state S3 to the second state S2, the first bracket 121 is gradually closed relative to the second bracket 122, the first abutting part 233 gradually moves closer to the first stop point 253a from the third stop point 253b, the second abutting part 243 continues to abut against the second stop point 254a, and the second torsion element 240 gradually releases the elastic potential energy to provide the fourth torque.

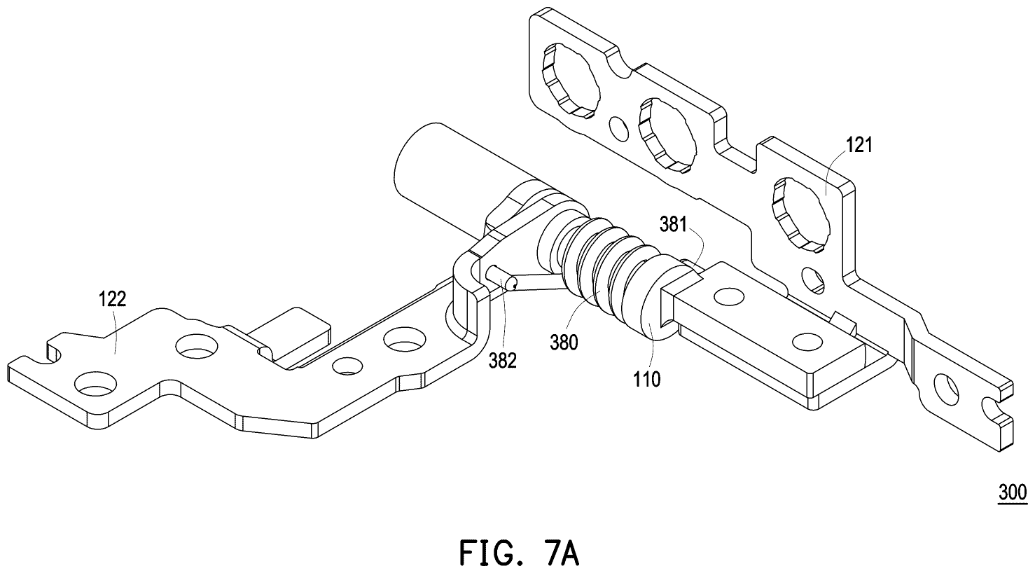

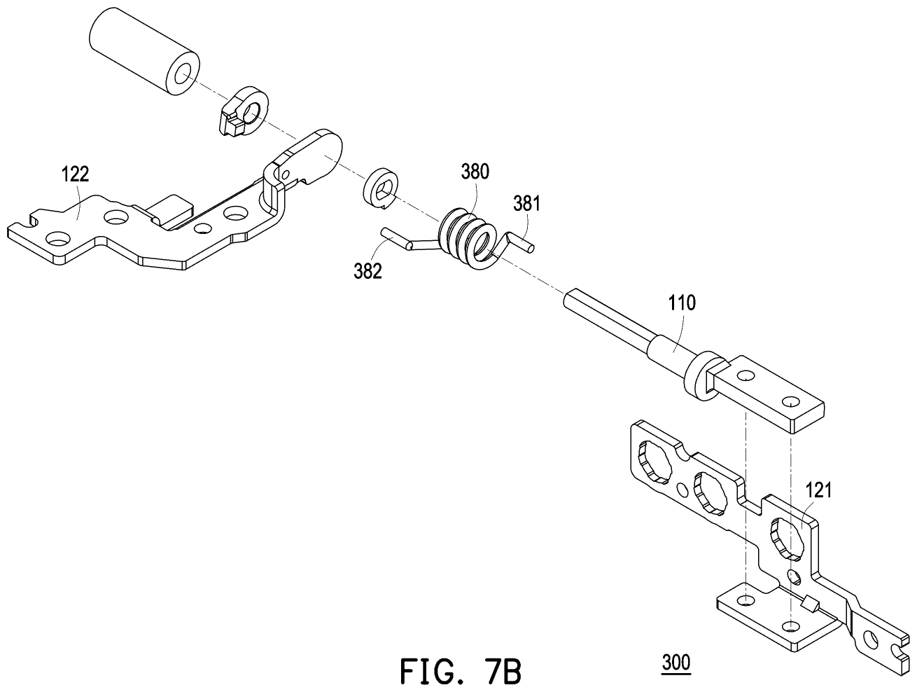

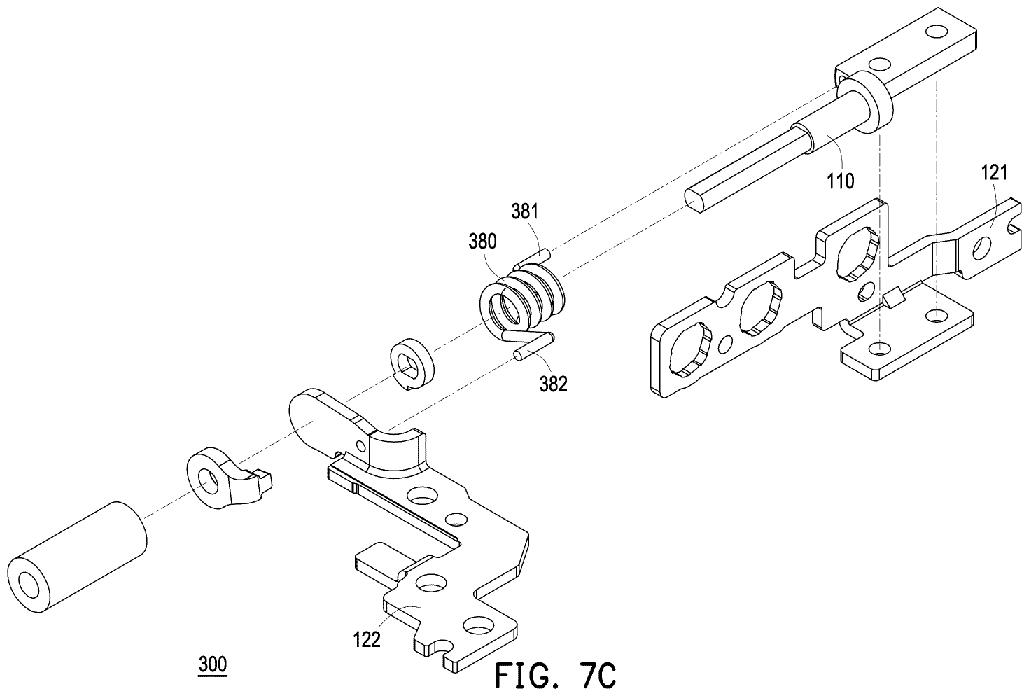

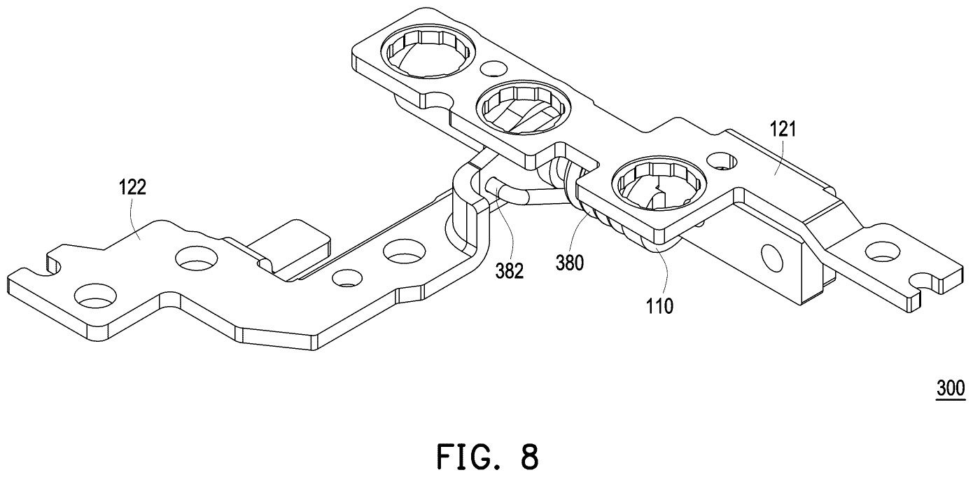

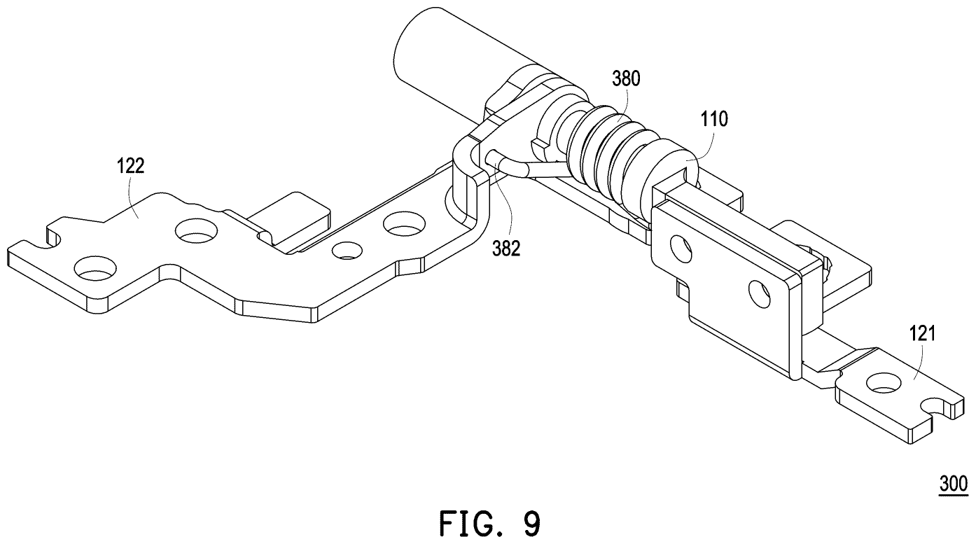

Please refer to FIG. 7A, FIG. 7B, FIG. 7C, FIG. 8, and FIG. 9. This embodiment provides a different hinge structure 300. The difference is that the structure of the hinge structure 300 is further streamlined, and components including the fastening component, the first rotating component, and the second rotating component are omitted, and the hinge structure 300 only includes a single torsion element 380. The torsion element 380 is sleeved on the rotating shaft 310, and the torsion element 380 has a first torsion end 381 and a second torsion end 382 opposite to each other. The first torsion end 381 is connected to the first bracket 121, and the second torsion end 382 is connected to the second bracket 122.

In summary, in the electronic device of the disclosure, the first torsion end is connected to the first bracket, and the second torsion end is connected to the second bracket, when the first bracket is gradually closed relative to the second bracket, the at least one torque component provides the first torque to the first bracket through the first torque end, and when the first bracket is gradually unfolded relative to the second bracket, the at least one torsion element provides the second torque to the second bracket through the second torsion end, thereby providing the user with the convenience of operating the unfolding and closing of the first body relative to the second body with one hand.

What is claimed is:

1. An electronic device, comprising:
a first body;
a second body; and
a hinge structure connected between the first body and the second body, comprising:
a rotating shaft;
a first bracket connected to the first body and the rotating shaft;
a second bracket connected to the second body and pivoted on the rotating shaft; and
at least one torsion element sleeved on the rotating shaft and having a first torsion end and a second torsion end opposite to each other, wherein the first torsion end is connected to the first bracket, and the second torsion end is connected to the second bracket;
wherein in response to the first bracket being gradually closed relative to the second bracket, the at least one torsion element provides a first torque to the first bracket through the first torsion end, and in response to the first bracket being gradually unfolded relative to the second bracket, the at least one torsion element provides a second torque to the second bracket through the second torsion end.

2. The electronic device as claimed in claim 1, wherein the hinge structure further comprises:
a fastening component sleeved on the rotating shaft, connected to the second bracket, and having a first movable area and a second movable area opposite to each other;
a first rotating component rotatably sleeved on the rotating shaft and having a first abutting part, wherein the first abutting part is adapted to move freely within a range of the first movable area;
a second rotating component rotatably sleeved on the rotating shaft and having a second abutting part, wherein the second abutting part is adapted to move freely within a range of the second movable area, and the first rotating component and the second rotating component are on two opposite sides of the fastening component;
a first torsion element sleeved on the rotating shaft and having a first fastening end opposite to the first torsion end, wherein the first fastening end is connected to the first rotating component, and the first rotating component is between the fastening component and the first torsion element; and
a second torsion element sleeved on the rotating shaft and having a second fastening end opposite to the second torsion end, wherein the second fastening end is connected to the second rotating component, and the second rotating component is between the fastening component and the second torsion element.

3. The electronic device as claimed in claim 2, wherein the first movable area has a first stop point, the first abutting part is adapted to abut against or move away from the first stop point, the second movable area has a second stop point opposite to the first stop point, and the second abutting part is adapted to abut against or move away from the second stop point.

4. The electronic device as claimed in claim 3, wherein the electronic device is adapted to switch between a first state, a second state, and a third state; in the first state, the first body is closed relative to the second body; in the second state, the first body is unfolded by a first included angle relative to the second body; in the third state, the first body is unfolded by a second included angle relative to the second body, and the second included angle is greater than the first included angle; wherein in response to the electronic device being in the second state, the first abutting part abuts against the first stop point, the second abutting part abuts against the second stop point, and the first torsion element and the second torsion element are not accumulating elastic potential energy.

5. The electronic device as claimed in claim 2, wherein the fastening component has a first side and a second side opposite to each other, the first movable area is on the first side, and the second movable area is on the second side.

6. The electronic device as claimed in claim 2, wherein the first bracket has a first slot, the first torsion end is engaged with the first slot, the second bracket has a second slot, and the second torsion end is engaged with the second slot.

7. The electronic device as claimed in claim 2, wherein the second bracket has a positioning hole, the fastening component has a positioning part, and the positioning part is engaged with the positioning hole.

8. The electronic device as claimed in claim 1, wherein the hinge structure further comprises:
a fastening component sleeved on the rotating shaft, connected to the second bracket, and having a first movable area and a second movable area opposite to each other;
a first torsion element sleeved on the rotating shaft and having a first abutting part opposite to the first torsion end, wherein the first abutting part is adapted to move freely within a range of the first movable area; and
a second torsion element sleeved on the rotating shaft and having a second abutting part opposite to the second torsion end, wherein the second abutting part is adapted to move freely within a range of the second movable area, and the first torsion element and the second torsion element are on two opposite sides of the fastening component.

9. The electronic device as claimed in claim 8, wherein the first movable area has a first stop point, the first abutting part is adapted to abut against or move away from the first stop point, the second movable area has a second stop point opposite to the first stop point, and the second abutting part is adapted to abut against or move away from the second stop point.

10. The electronic device as claimed in claim 9, wherein the electronic device is adapted to switch between a first state, a second state, and a third state; in the first state, the first body is closed relative to the second body; in the second state, the first body is unfolded by a first included angle relative to the second body; in the third state, the first body is unfolded by a second included angle relative to the second body, and the second included angle is greater than the first included angle; wherein in response to the electronic device being in the second state, the first abutting part abuts against the first stop point, the second abutting part abuts against the second stop point, and the first torsion element and the second torsion element are not accumulating elastic potential energy.

11. The electronic device as claimed in claim 8, wherein the fastening component has a first side and a second side opposite to each other, the first movable area is on the first side, and the second movable area is on the second side.

12. The electronic device as claimed in claim 8, wherein the first bracket has a first slot, the first torsion end is engaged with the first slot, the second bracket has a second slot, and the second torsion end is engaged with the second slot.

13. The electronic device as claimed in claim 8, wherein the second bracket has a positioning hole, the fastening component has a positioning part, and the positioning part is engaged with the positioning hole.

14. The electronic device as claimed in claim 1, wherein the hinge structure comprises:
a torsion element sleeved on the rotating shaft and having the first torsion end and the second torsion end.
